(19) United States
(12) Patent Application Publication
(10) Pub. No.: US 2008/0180707 A1
(43) Pub. Date: Jul. 31, 2008

(54) IMAGE PROCESSING APPARATUS, IMAGE PROCESSING SYSTEM, AND IMAGE PROCESSING METHOD

(75) Inventor: Shinichi Kanematsu, Inagi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/021,224

(22) Filed: Jan. 28, 2008

(30) Foreign Application Priority Data
Jan. 30, 2007 (JP) 2007-019468

(51) Int. Cl. G06F 15/00

(52) U.S. Cl. 358/1.9; 358/1.15

(57) ABSTRACT

An image processing apparatus includes a processing amount index calculation unit configured to analyze content of image data that is independent of print resolution and to calculate a processing amount index indicating a processing amount necessary in converting the image data into a bitmapped image, a storing unit configured to store the calculated processing amount index as additional information associated with the image data, and a sending unit configured to send the image data and the additional information.

### BACKGROUND OF THE INVENTION

1. Field of the Invention

The present invention relates to an image processing system configured to estimate time necessary in printing data and a control method.

2. Description of the Related Art

In recent years, there has been a demand for connecting a great number of image processing apparatuses, such as a printer, a scanner, a digital copier, and a facsimile machine, and coordinating them to enhance their functions and to realize a high productivity. In order to meet such demand, an image data format that is used for transmitting images between image processing apparatuses has been developed. This image data format (hereinafter referred to as vector data) is independent of print resolution.

The image processing apparatus which receives the vector data rasterizes the vector data into a bitmapped image. Therefore, image degradation due to resolution conversion does not occur and a fine image can be acquired as the most suitable bitmapped image for each image processing apparatus is generated. The vector data technique is important in coordinating various types of devices having different capabilities. Further, a technique has been developed in which various types of information that is not targeted for printing is associated with the vectorized image data for easier processing and for easier image search.

Further, by storing an image that is input by an image input apparatus as a file in a secondary storage device of an image output apparatus, the image can be repeatedly output whenever a user wishes to output the image. A function of an image output apparatus in which data is stored in a file format in a secondary storage device for the purpose of reuse is called a box function and the file system is called a box system. The box function enables a user to repeatedly reuse previously generated image data, for example, to reprint the stored image data or to send the stored image data to other image processing apparatuses with different capabilities.

For a user of such an image processing apparatus, it would be useful if the end time of a job can be precisely estimated during the process. Japanese Patent Application Laid-Open No. 2001-22544 discusses a digital copying machine that includes a user interface that displays an estimated end time, and a technique in which a user is notified of the estimated end time by an application on a host computer.

Time necessary in printing until the print is output is classified into two periods:

(1) Rasterization of vector data and generation of bitmapped image; and
(2) Transmission of bitmapped images of all pages to a printer engine and formation of the images.

A precise estimation of period (2) can be calculated based on the number of pages to be printed and the capability of the printer engine (print speed). However, estimation of period (1) is not simple for a variety of reasons. For example, the period (1) varies greatly depending on data content and rasterization capability of the image processing apparatus. Generally, rasterization processing of character data (text region) is quicker than image data. Further, an amount of processing needed for image data differs greatly depending on the number of rendering objects. Furthermore, processing time of an image processing apparatus varies greatly between an apparatus having a dedicated hardware for rasterization and an apparatus which rasterizes data using software. In addition, if software is used for rasterization, processing time differs greatly depending on a processing capability of a central processing unit (CPU) and a memory capacity of the apparatus.

Japanese Patent Application Laid-Open No. 2001-22544 discusses a technique by which estimated processing time is calculated considering a type of a rendering object included in page description data and a processing capability of an image processing apparatus which outputs the data. The estimated processing time is added to the image data or stored in an apparatus on the image data generation side as additional information that is not printed. Thus, estimated processing time which is once estimated in association with certain image data can be reused if the same image data is output from the same image processing apparatus. In addition, Japanese Patent Application Laid-Open No. 2001-22544 discusses a solution to a timing problem that occurs when time is calculated by the receiving apparatus. Previously, time could not be calculated until analysis of the whole content of the page description data is finished.

However, in Japanese Patent Application Laid-Open No. 2001-22544, the apparatus that sends data needs to know processing capability of the output image processing apparatus in advance for calculating the time (1). In future coordination of image processing apparatuses, it is required that various devices which are connected on a network send, receive, and store images in a flexible manner. However, when a new image processing apparatus is added or an optional feature is added to or removed from an image processing apparatus, capability of the apparatus is also changed. Accordingly, when an image is transmitted to a great number of image processing apparatuses or when a destination image processing apparatus is changed, capability of the destination apparatus needs to be collected for each time.

Further, since the estimated processing time of each destination apparatus is calculated by the image sending apparatus using the above-described capability information, processing load of the image sending apparatus increases when the number of destination apparatuses is increased.

Furthermore, when image data which is stored in a box system is used, estimated processing time of the image data cannot be used even if the image data includes estimated processing time as additional information.

### SUMMARY OF THE INVENTION

The present invention is directed to realizing efficient calculation and reuse of estimated time information.

According to an aspect of the present invention, an image processing apparatus includes a processing amount index calculation unit configured to analyze content of image data that is independent of print resolution and to calculate a processing amount index indicating a processing amount necessary in converting the image data into a bitmapped image, a storing unit configured to store the calculated processing amount index as additional information associated with the image data, and a sending unit configured to send the image data and the additional information.

According to an exemplary embodiment of the present invention, efficient calculation and reuse of estimated time information can be performed as well as earlier calculation of the print processing.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a side sectional elevation of a structure of a multifunction peripheral (MFP) according to an exemplary embodiment of the present invention.

FIG. 2 is a block diagram illustrating a configuration example of a control unit of each device according to an exemplary embodiment of the present invention.

FIG. 3 illustrates an example of a system configuration according to an exemplary embodiment of the present invention.

FIG. 4 is a block diagram illustrating a configuration example of a controller software according to an exemplary embodiment of the present invention.

FIG. 5 illustrates an example of a display screen of an operation unit according to an exemplary embodiment of the present invention.

FIG. 6 illustrates an example of a display screen of an operation unit according to an exemplary embodiment of the present invention.

FIG. 7 illustrates an example of a display screen of an operation unit according to an exemplary embodiment of the present invention.

FIG. 8 illustrates an example of a region segmentation in vectorization processing according to an exemplary embodiment of the present invention.

FIG. 9 is a data flow diagram illustrating flow of data in generating a document starting with image scanning according to an exemplary embodiment of the present invention.

FIG. 10 is a data flow diagram illustrating flow of data in generating a document starting with a printer driver according to an exemplary embodiment of the present invention.

FIG. 11 is a data flow diagram illustrating flow of data in generating metadata according to an exemplary embodiment of the present invention.

FIG. 12 is a data flow diagram illustrating flow of data in printing a page description language (PDL) document according to an exemplary embodiment of the present invention.

FIG. 13 is a flowchart illustrating document generation starting with input data according to an exemplary embodiment of the present invention.

FIG. 14 is a flowchart illustrating document print processing according to an exemplary embodiment of the present invention.

FIG. 15 is a flowchart illustrating processing of PDL data according to an exemplary embodiment of the present invention.

FIG. 16 illustrates a data structure of a document according to an exemplary embodiment of the present invention.

FIG. 17 illustrates a document filing structure according to an exemplary embodiment of the present invention.

FIG. 18 illustrates an example of document data according to an exemplary embodiment of the present invention.

FIG. 19 illustrates a configuration of a system for printing documents having different processing amounts according to an exemplary embodiment of the present invention.

FIG. 20 is a flowchart illustrating a printing process of PDL data according to an exemplary embodiment of the present invention.

FIG. 21 is a calculation example of processing time estimated from documents having different processing amounts according to an exemplary embodiment of the present invention.

FIG. 22 is a calculation example of estimated processing time of apparatuses having different processing capabilities according to an exemplary embodiment of the present invention.

FIG. 23 illustrates a system configured to store a document according to an exemplary embodiment of the present invention.

FIG. 24 illustrates a configuration of a system capable of allowing different apparatuses to perform printing operation at the same time according to an exemplary embodiment of the present invention.

FIG. 25 illustrates an example of combining documents according to an exemplary embodiment of the present invention.

### DETAILED DESCRIPTION OF THE EMBODIMENTS

Various exemplary embodiments, features, and aspects of the present invention are described in detail below with reference to the drawings.

### First Exemplary Embodiment

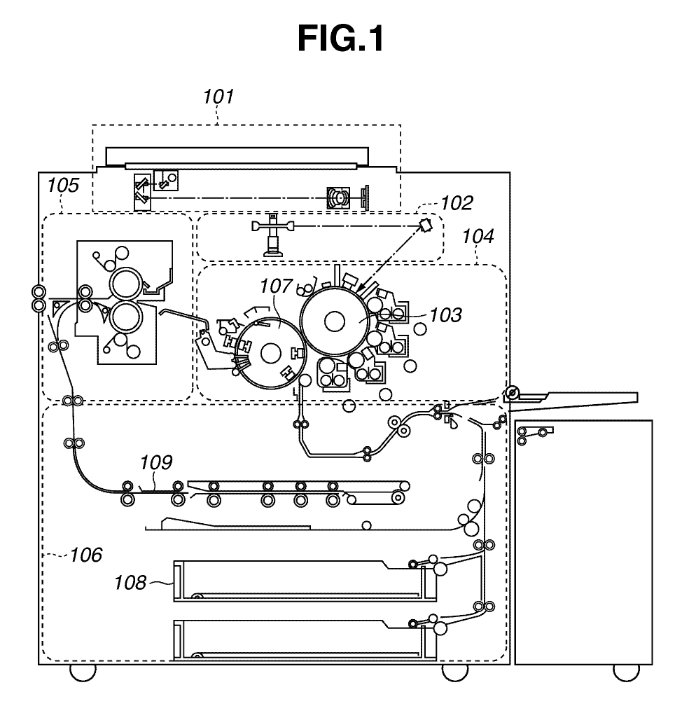

A configuration of a one-drum (1D) color MFP according to an exemplary embodiment of the present invention is described with reference to FIG. 1.

The 1D color MFP is configured to form an image on a sheet as a physical medium. The ID color MFP includes a scanner unit 101, a laser exposure unit 102, a photosensitive drum 103, an image forming unit 104, a fixing unit 105, a paper feed/convey unit 106, and a printer control unit (not shown) controlling all of these units.

The scanner unit 101 illuminates a document placed on a document positioning plate to optically scan the document image, converts the image into an electric signal, and forms image data.

The laser exposure unit 102 directs a light beam which is modulated depending on the image data, such as a laser beam, to a polygonal mirror which rotates at a constant angular speed. The reflected light is emitted to the photosensitive drum 103 as reflected scanning light.

The image forming unit 104 is configured to form an image by a series of electrophotographic processes including rotating the photosensitive drum 103, applying an electric charge to a charging unit, developing a latent image formed on the photosensitive drum 103 by the laser exposure unit 102 with toner, and transferring the toner image to a sheet. The image forming unit 104 also recovers a minute amount of toner which remains untransferred on the photosensitive drum 103. While a transfer drum 107 makes four rotations, the sheet is set on a predetermined position on the transfer drum 107 and developing units (developing stations) for magenta (M), cyan (C), yellow (Y), and black (K) toner sequentially repeat the aforementioned electrophotographic process. After making four rotations, the sheet having a four full-color transferred toner image is conveyed from the transfer drum 107 to the fixing unit 105.

The fixing unit 105 includes a combination of rollers and belts and a heat source, such as a halogen heater. The fixing unit 105 applies heat and pressure to fix the toner which is transferred to the sheet by the image forming unit 104.

The paper feed/convey unit 106 includes one or more sheet storage spaces represented by a sheet cassette or a paper deck. According to an instruction from the printer control unit, one sheet out of a plurality of sheets stored in a sheet storage space 108 is separated and conveyed to the image forming unit 104. The sheet is wound around the transfer drum 107 of the image forming unit 104 and conveyed to the fixing unit 105 after the transfer drum 107 makes four rotations. During the four rotations, a toner image of the aforementioned each YMCK color is transferred to the sheet. Further, for forming images on both sides of the sheet, the sheet which passed through the fixing unit 105 is controlled to be conveyed to the image forming unit 104 again through a conveyance path 109.

The printer control unit communicates with an MFP control unit which controls the entire MFP. Based on an instruction from the MFP control unit, the printer control unit controls each state of the above-described scanner, laser exposure, image forming, fixing, and paper feed/convey units so that the entire printing process is operated smoothly. The MFP is programmed in accordance with the present invention as described in detail below.

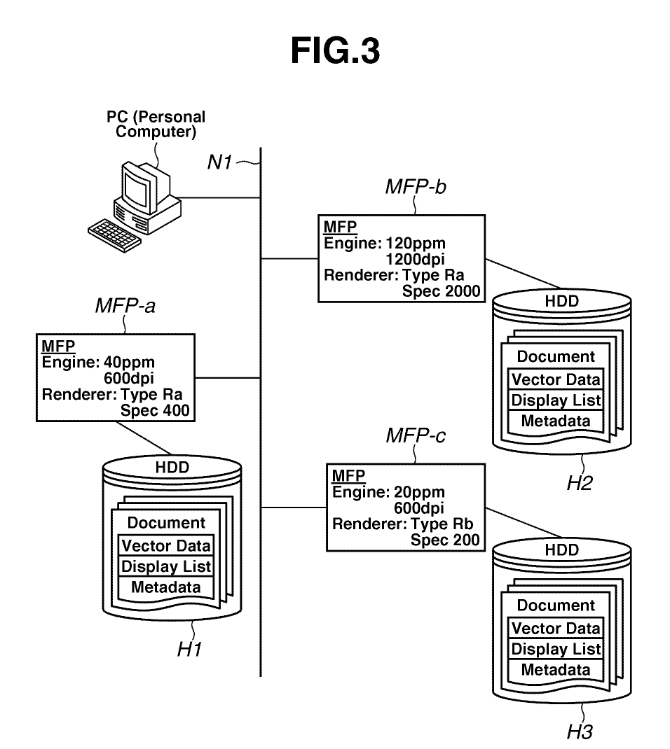

FIG. 3 is a block diagram illustrating an overall configuration of the image processing system according to the present exemplary embodiment. In FIG. 3, the image processing system includes a personal computer (PC), an MFP-a, an MFP-b, and an MFP-c, all of which are connected via a local area network (LAN) N1 or the like.

The PC generates image data, generates a processing time index of the image data in association with the image data as additional information, and sends the image data and additional information to each MFP.

MFP-a, MFP-b, and MFP-c, include a hard disk drive (HDD) H1, an HDD H2, and an HDD H3, respectively. Each HDD is a secondary storage device. Each printer engine (hereinafter referred to as the “engine”), which is installed in each MFP, has a different print resolution and a different print speed (number of printing pages per minute: ppm). The MFP-a has a print resolution of 600 dots per inch (dpi) and has a print speed of 40 ppm, the MFP-b has a print resolution of 1200 dpi and has a print speed of 120 ppm, and the MFP-c has a print resolution of 600 dpi and has a print speed of 20 ppm.

A processing capability and type of a renderer (or a rasterizer) installed in the MFP is different for each MFP. The MFP-a and the MFP-b include a renderer of a similar type (referred to as “Ra” in FIG. 3). On the other hand, the MFP-c includes a renderer of a different type (referred to as “Rb” in FIG. 3). The processing capability is expressed in an index. The processing capability of the MFP-a is 400, the MFP-b is 2000, and the MFP-c is 200. A larger index indicates faster processing speed. In FIG. 3, although the MFP-a and the MFP-b include a renderer of a similar type, the MFP-a uses software for processing while the MFP-b uses a dedicated hardware. Accordingly, their rendering speeds are different.

Generally, a renderer is not capable of processing a rendering instruction group which is rendered by a different type of renderer. The rendering instruction group is generally called a Display List (hereinafter referred to as “DL”). The DL, which is generated by software from vector data having a complex rendering description, is an instruction that can be processed by hardware. The DL is dependent on print resolution.

The MFP-a, the MFP-b, the MFP-c, and the PC can communicate with each other using a network protocol. The arrangement of the MFPs connected via the LAN N1 is not limited to the above-described physical arrangement. Further, an apparatus other than an MFP, such as a server or a printer for example, can be additionally connected to the LAN N1.

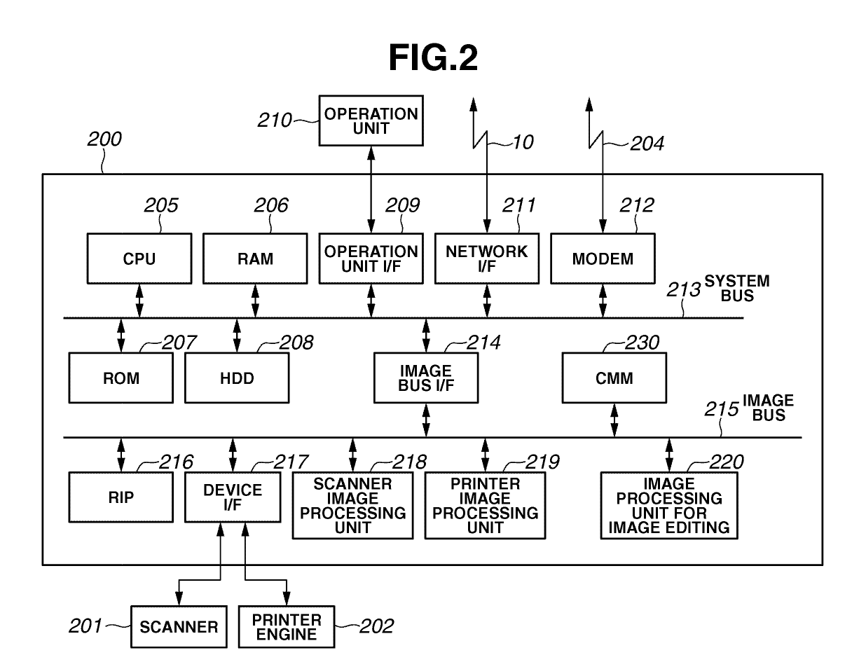

FIG. 2 is a block diagram illustrating a configuration example of a control unit (controller) 200 of the MFP according to the present embodiment. In FIG. 2, the control unit 200 is connected to a scanner 201 as an image input device and a printer engine 202 as an image output device and controls scanning of image data or output of print data. Further, the control unit 200 can control input and output of image information and device information through a LAN 10 when it is connected to the LAN 10 or a public line 204.

A CPU 205 is a central processing unit configured to control the entire MFP. A RAM 206 is a system work memory used in operation of the CPU 205. The RAM 206 is also an image memory used as a temporary storage of the input image data. Further, a ROM 207 is a boot ROM where a system boot program is stored. An HDD 208 is a hard disk drive in which system software used for various types of processing and input image data can be stored. The system software stored in the HDD 208 includes program code for implementing processing in accordance with the present invention.

An operation unit interface (I/F) 209 is an interface unit for an operation unit 210. The operation unit 210 has a display screen configured to display data, such as the image data and text data. The operation unit I/F 209 is configured to transmit operation screen data to the operation unit 210. Further, the operation unit I/F 209 is used for transmitting information input by an operator via the operation unit 210 to the CPU 205. A network interface 211 includes, for example, a LAN card or the like. When the network interface 211 is connected to the LAN 10, the network interface 211 sends and receives information to and from an external apparatus. Further, a modem 212, which is connected to the public line 204, sends and receives information to and from an external apparatus. The above-described units are arranged on a system bus 213.

An image bus I/F 214 is an interface configured to connect the system bus 213 to an image bus 215 which is used for transferring image data at a high speed. The image bus I/F 214 is also a bus bridge configured to convert a data structure. Other units connected to the image bus 215 are a raster image processor (RIP) 216, a device I/F 217, a scanner image processing unit 218, a printer image processing unit 219, an image processing unit for image editing 220, and a color management module (CMM) 230.

The RIP 216 is configured to rasterize PDL code or vector data into a bitmapped image. The device I/F unit 217 connects the control unit 200 to the scanner 201 and the printer engine 202. The device I/F unit 217 is used for synchronous/asynchronous conversion of the image data.

The scanner image processing unit 218 is configured to perform various types of processing to image data which is output from the scanner 201, such as correction, processing, and editing. The printer image processing unit 219 makes corrections to the image data to be printed and converts its resolution according to a capability of the printer engine 202. The image processing unit for image editing 220 is configured to make various types of image processing, such as rotation, reduction, and expansion of the image data. The CMM 230 is a hardware module dedicated for color conversion processing, also referred to as color space conversion processing, of the image data based on a profile or calibration data. The profile is function-like information used for converting color image data expressed in a device-dependent color space into a device-independent color space, such as the Lab color space (also commonly known as the CIE 1976 (L*, a*, b*) color space and CIELAB). The calibration data is used for adjusting color reproduction characteristics of the scanner 201 and the printer engine 202 in the color multifunction peripheral.

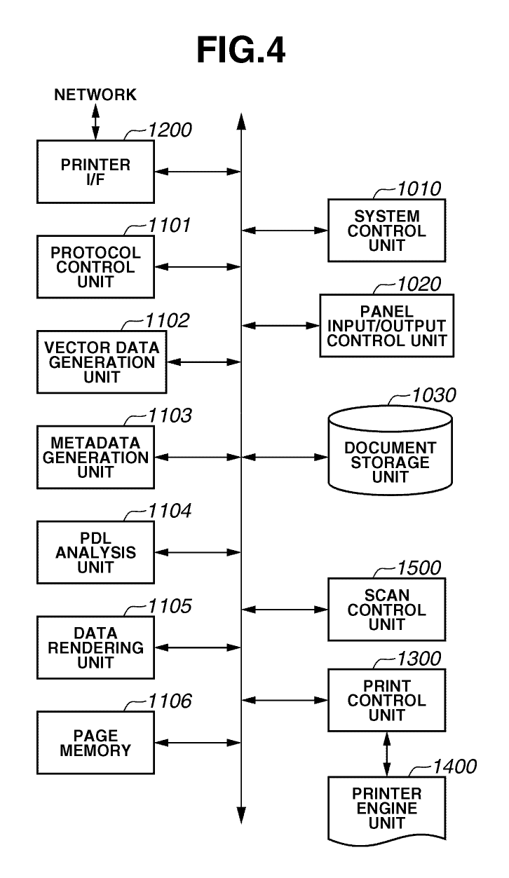

FIG. 4 is a block diagram illustrating a configuration example of a controller software configured to control the operation of the MFP. A program configured to realize functions of each of the following software is stored in the HDD 208 or alternatively in the ROM 207 and executed by the CPU 205 illustrated in FIG. 2.

A printer interface 1200 is a unit configured to transfer input/output data to and from an external apparatus. A protocol control unit 1101 is a unit configured to perform communication with an external apparatus by analyzing and sending a network protocol.

A vector data generation unit 1102 generates vector data or vectorizes data from a bitmapped image. The vector data is independent of print resolution.

A metadata generation unit 1103 generates secondary information acquired during the vectorization process as metadata. The metadata is additional data used, for example, for searching but not used for rendering. A processing amount index necessary in rendering the vector data is also generated as metadata.

A PDL analysis unit 1104 is a unit configured to analyze the PDL data and convert the PDL data into intermediate code (Display List) which is a format that enables easier processing. The intermediate code generated by the PDL analysis unit 1104 is sent to a data rendering unit 1105. The data rendering unit 1105 rasterizes the above-described intermediate code into bitmapped data. The bitmapped data is successively stored in a page memory 1106.

The page memory 1106 is a volatile memory configured to temporarily store the bitmapped data rendered by the data rendering unit 1105. A panel input/output control unit 1020 controls input/output to and from the operation panel.

A document storage unit 1030 is a unit configured to store a data file which contains vector data, a Display List, and metadata in units of input document job. The document storage unit 1030 is a secondary storage device, such as a hard disk. This data file is referred to as a “document” in the present exemplary embodiment.

A scan control unit 1500 is configured to perform various processing on the image data output from the scanner, such as correction, processing, and editing.

A print control unit 1300 converts content of the page memory 1106 into a video signal and transfers the video signal to a printer engine unit 1400. The printer engine unit 1400 is a printing mechanism unit configured to form an image on a recording sheet from the received video signal.

A system control unit 1010 organizes the above-described various types of software control units and controls the entire MFP as a system. Further, the system control unit 1010 collects print speed (ppm) of the printer engine and processing capability (index) of the renderer at the time of system start-up and stores the data in the RAM 206 (processing capability index storage).

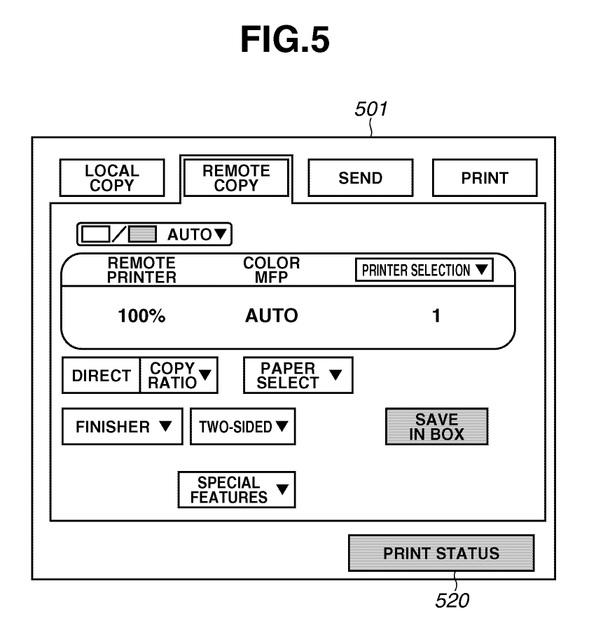

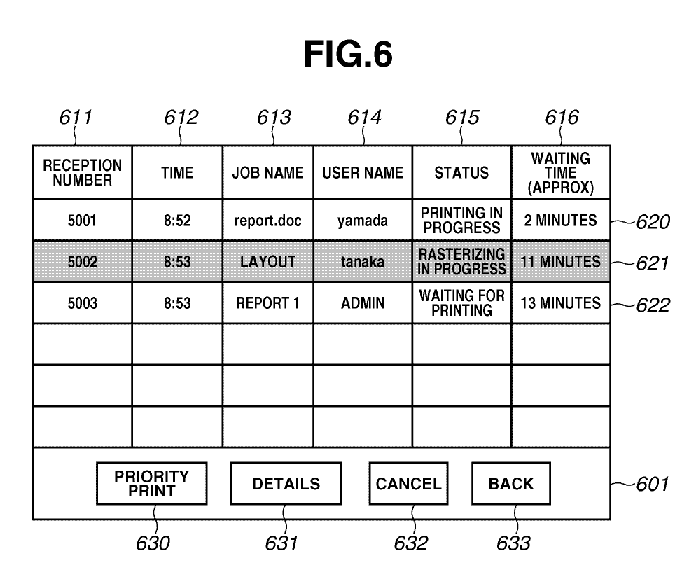

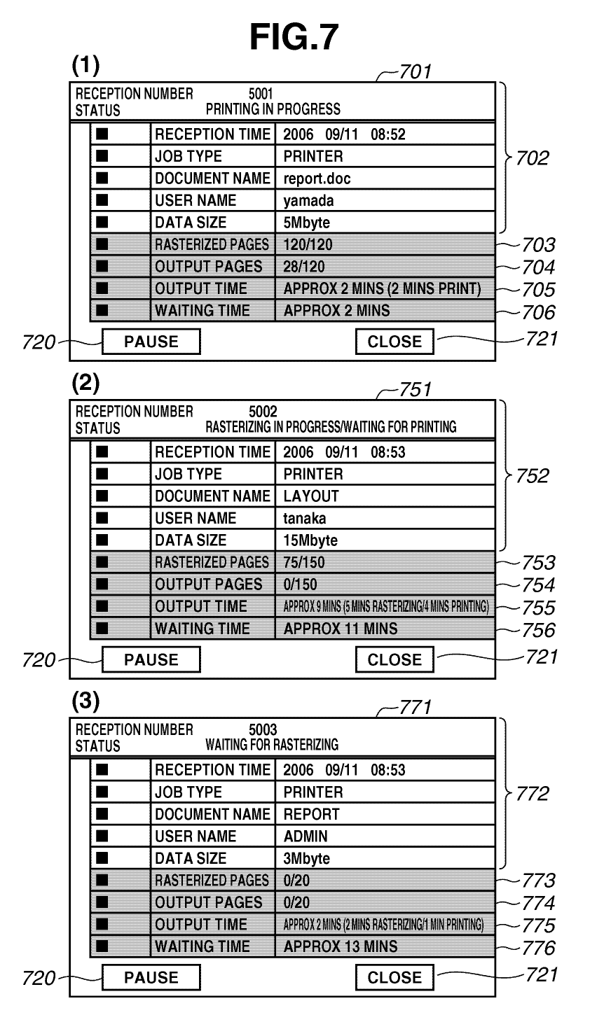

Further, the system control unit 1010 controls operation in units, such as print operation and scan operation, as a job, controls the panel input/output control unit 1020, and displays a processing status of the job on the operation unit 210. FIGS. 5, 6, and 7 illustrate a display screen of the operation unit 210 of the MFP according to an exemplary embodiment of the present invention. FIG. 5 illustrates a basic screen 501 for the MFP. By selecting a print status button 520, a print job list screen 601 appears as illustrated in FIG. 6. Further, by selecting a details button 631 on the print job list screen 601 (the selected job is highlighted), detailed information of each job is displayed as illustrated in FIG. 7. Further detail regarding these figures is provided below.

Next, generation of the vector data, Display List (DL), and metadata, which are included in a document, will be described.

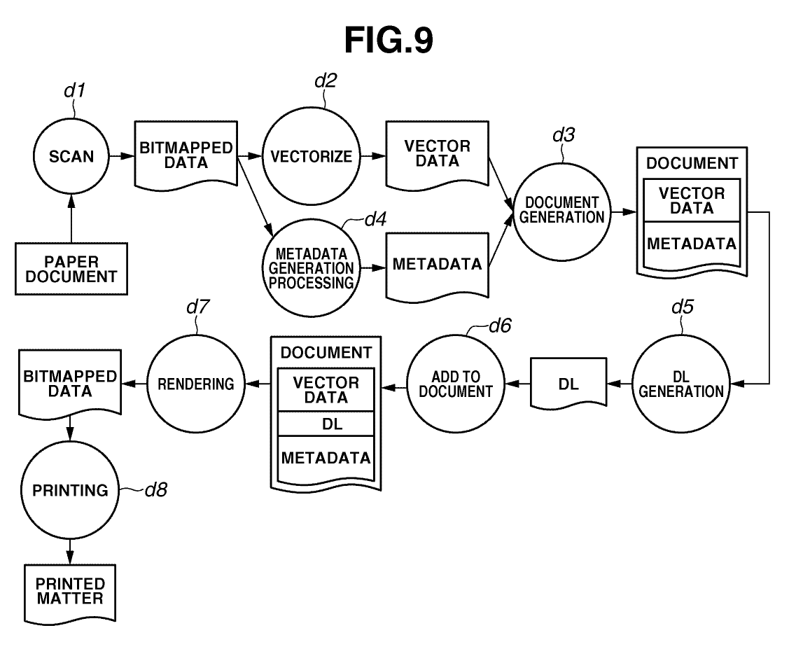

FIGS. 9, 10, 11, and 12 illustrate a data flow in the control unit 200 according to the present exemplary embodiment.

FIG. 9 illustrates a data flow during the copy operation. First, image data of a paper document set on a document exposure unit is converted into bitmapped data by scan processing d1. Next, vector data which is independent of print resolution is generated from the bitmapped data by vector processing d2. At the same time, metadata which is associated with the vector data is generated by metadata generation processing d4. Generation of the vector data and the metadata is described below.

Next, a document in which the vector data is associated with the metadata is generated by document generation processing d3. Subsequently, by DL generation processing d5, a DL is generated from the vector data in the document. The generated DL is stored in the document and transferred to rendering processing d7 to be converted into a bitmapped image.

The bitmapped image is recorded on a paper medium by print processing d8 and is output as a print product. The entire processing starting with the scanning processing d1 can be repeated by setting the print product on the document exposure unit.

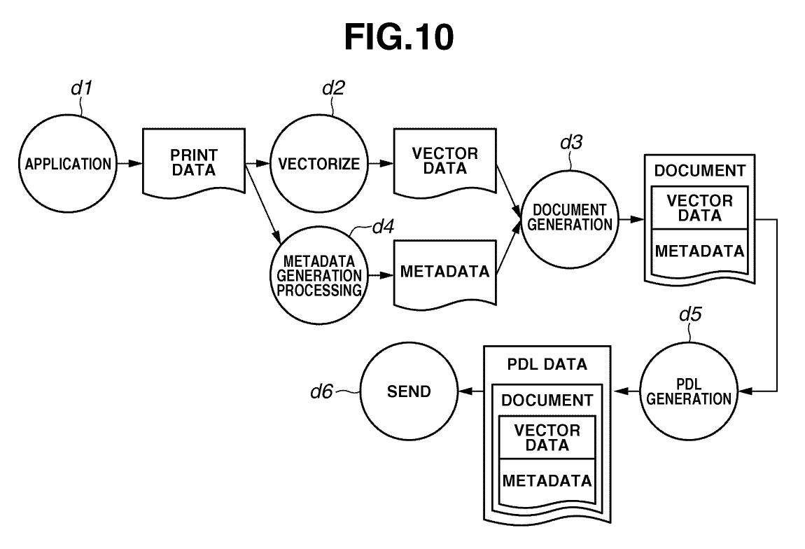

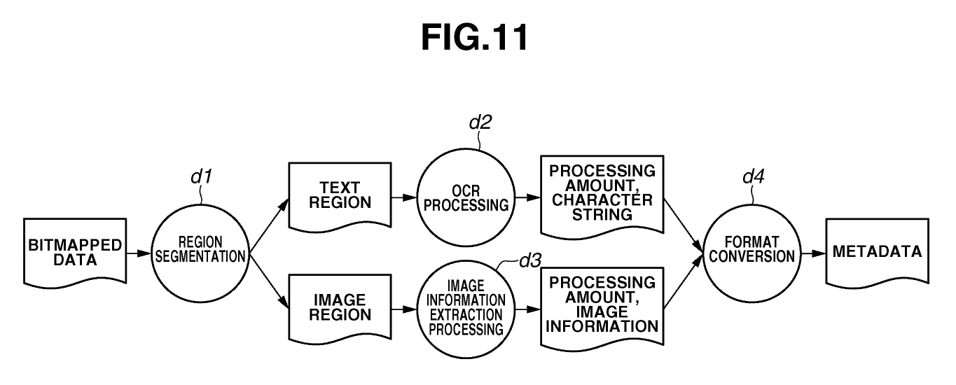

FIG. 11 illustrates an actual data flow by the metadata generation processing d4 illustrated in FIGS. 9 and 10 (described below).

First, a region segmentation of the bitmapped image is performed by region segmentation processing d1.

The region segmentation is performed by analyzing the bitmapped image data which is input, segmenting the data into regions according to an object included in the image, and determining and classifying an attribute of each region. The attribute of the regions is, for example, text (TEXT), photo (PHOTO), line (LINE), picture (PICTURE), or table (TABLE).

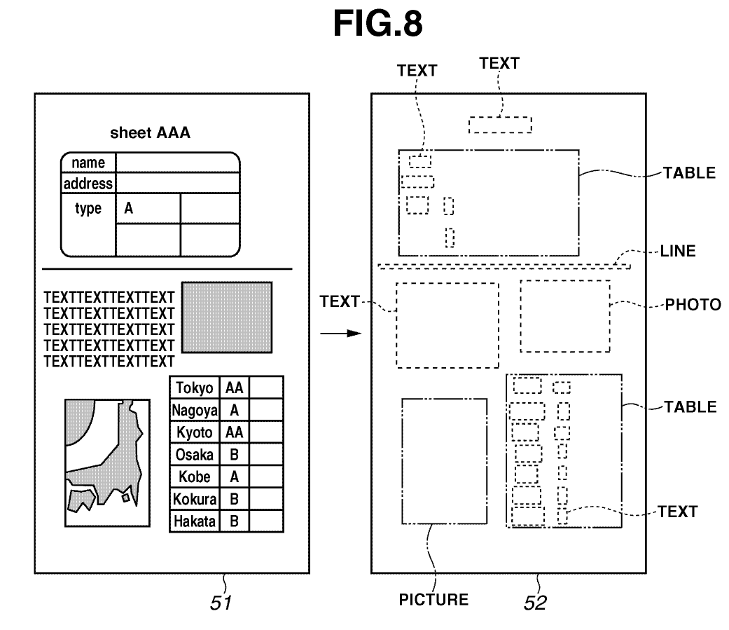

Referring now also to FIG. 8, an example of the region segmentation of an input image is illustrated. A determination result 52 is a result of a region segmentation of an input image 51. In the determination result 52, each area surrounded by dotted lines indicates an object unit after the analysis of the image. A type of an attribute given to each object is a result of the determination of the region segmentation.

Referring still to FIG. 11, among the regions classified by the attributes, regions having a text attribute are character-recognized by OCR processing d2 and converted into a character string. The character string is a string of characters that are printed on paper.

On the other hand, the image attribute region in the regions classified by the attribute is converted into image information by image information extraction processing d3. The image information is a character string that expresses a feature of the image, such as “flower” or “face”. A conventional image processing technique using image feature quantity detection or face recognition can be used for extracting the image information. The image feature quantity is a frequency or a density of pixels included in an image. Further, according to the attribute of the region-segmented object, an index of a processing amount necessary in rendering each object is calculated (processing amount index calculation). The calculation of the index is based on the attribute or number of characters or lines included in the object. For PHOTO and PICTURE objects, color scale and paint type (gradation, translucency) will be added to the index of the processing amount. Further, as for processing required in a superposition of a plurality of objects within a page or processing of a translucent image, the image is generated as metadata in a page unit.

The generated character string and image information and their processing amount indexes are arranged in a data format by format conversion processing d4 to generate metadata.

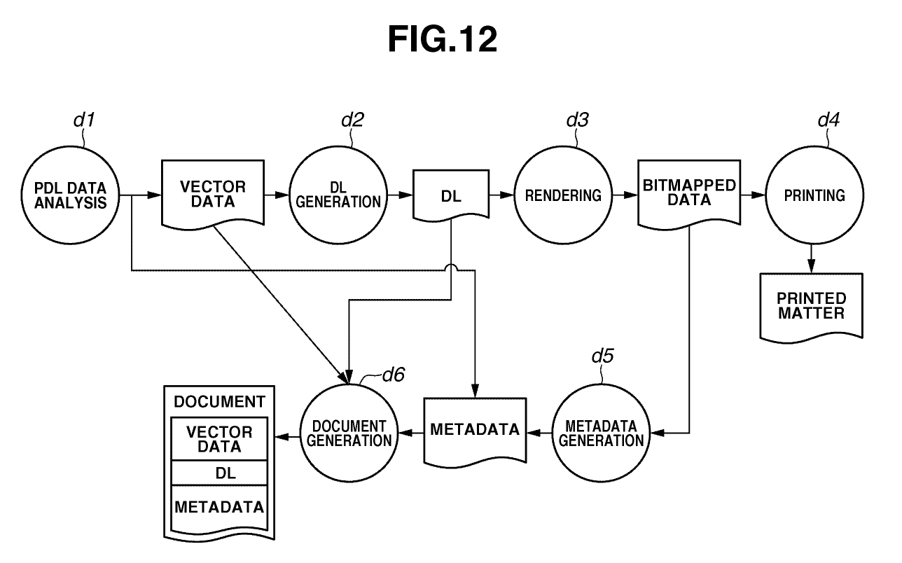

FIGS. 10 and 12 illustrate a data flow during PDL printing. In a case where printing is instructed from application software in the PC, a PDL generated by the printer driver on the PC is received and printed. This printing operation is called PDL printing.

First, the PDL data generation by a printer driver on a PC will be described referring to FIG. 10. Print data, which is sent to the printer driver by an application in processing d1, is vectorized in processing d2 while its metadata is generated in processing d4. Processing up to document generation processing d3 is achieved in the same manner as (or alternatively similar to) that illustrated in FIG. 9 except that the print data is not bitmapped image but data output by an application. In processing d5, page description data is generated depending on a type of PDL which is supported by the printer driver. The PDL is, for example, LBP Image Processing System (LIPS)™ or PostScript (PS)™. LBP Image Processing System (LIPS) is available from Canon Kabushiki Kaisha of Tokyo, Japan. PostScript® (PS) refers to any of Postscript Level 1, PostScript Level 2, or Postscript 3, and is available from Adobe Systems Incorporated of San Jose, Calif. In processing d6, the PDL data is sent to an MFP. The data is printed or stored by the MFP.

Next, a data flow on the side of the image processing apparatus which has received the PDL data will be described with reference to FIG. 12. First, the received PDL data is analyzed by PDL data analysis processing d1 and vector data is generated. Next, in DL generation processing d2, DL data is generated from the vector data. The generated DL is stored in the document but is also sent to rendering processing d3 and rasterized into a bitmapped image. The bitmapped image is recorded on a paper medium by print processing d4 and is output as a printed matter.

Further, from the bitmapped image generated by the rendering processing d3, a character string and image information are generated as metadata by metadata generation processing d5, which is described above referring to FIG. 11. This metadata is generated as in the processing of the copy operation, described above with respect to FIG. 9.

A PDL including character string information is included in the various types of PDL, including LIPS and PS. With such a PDL, additional metadata is generated from a character string when the PDL is analyzed d1. The metadata generated in metadata generation d5 and the additional metadata from PDL data analysis d1 are stored in the document during document generation d6.

The vector data generated in the PDL data analysis d1 and the DL generated in DL generation d2 are stored in the document by the document generation processing d6.

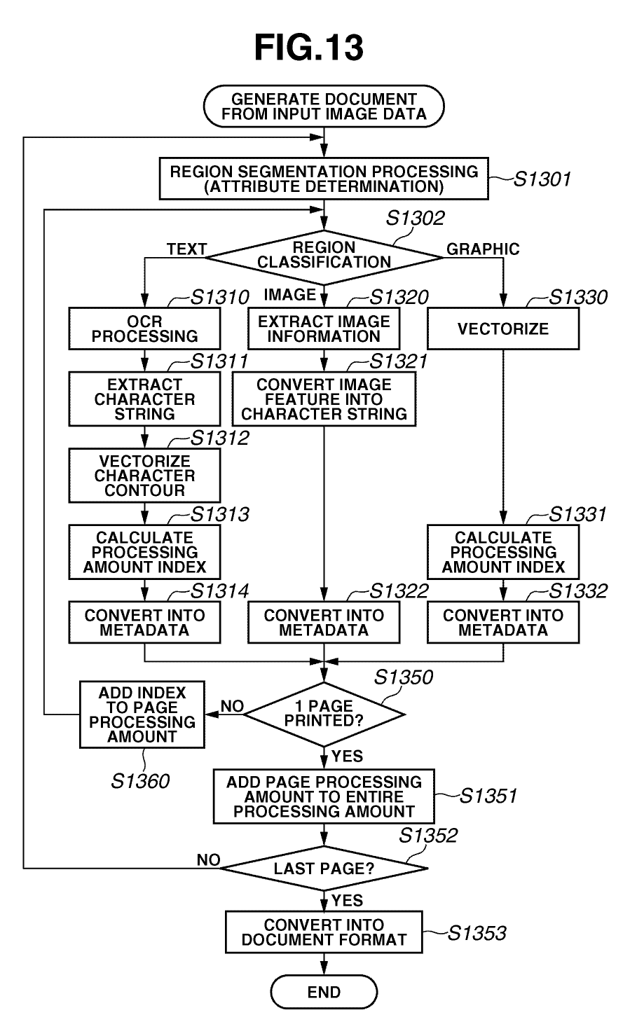

Next, document generation processing and print processing will be described referring to FIGS. 13 to 15. FIG. 13 illustrates the document generation processing. A document including vector data, DL, and metadata is generated from the input image data according to this processing.

In step S1301, the system control unit 1010 executes the aforementioned region segmentation processing of the input image data. In the following description, a segmented region may be referred to as an “object”. In step S1302, the system control unit 1010 classifies a type or attribute of each region into TEXT, GRAPHIC, or IMAGE. The TEXT, GRAPHIC, and IMAGE go under different processing. For example, regarding attributes which are classified into TEXT, PHOTO, LINE, PICTURE, and TABLE in FIG. 8, TEXT is classified into TEXT, PHOTO and PICTURE are classified into IMAGE, and LINE and TABLE are classified into GRAPHIC.

If the region attribute is TEXT, then the process proceeds to step S1310. The system control unit 1010 executes OCR processing in step S1310, extracts a character string in step S1311, and converts a recognized character contour into vector data in step S1312. Then in step S1313, the system control unit 1010 calculates a processing amount necessary in rendering as an index. In step S1314, the system control unit converts the character string extracted in step S1311 as well as the processing amount index calculated in S1313 into metadata.

Although the metadata generated from the character string is a collection of character code, the character code is information necessary in a keyword search. However, even if the character code is recognized in the OCR processing, font types, such as “Mincho” or “Gothic”, character size, such as “10 pt” or “12 pt”, and font attributes, such as “italic” or “bold” are not recognized. Thus, not the character code but the character contour is stored as vector data for rendering.

On the other hand, if the region attribute is IMAGE in step S1302, the process proceeds to step S1320. In step S1320, the system control unit 1010 extracts image information. In this step, a feature of an image is detected by using a conventional image processing technique, such as the image feature quantity detection or the face recognition. In step S1321, the system control unit 1010 converts the detected image feature into a character string. This conversion will be easy if a table that contains feature parameter and character string is ready for use. Vectorization will not be made to the region attribute of IMAGE. Since image data can be stored as vector data, rendering processing is unnecessary. Thus, in the case of IMAGE, the system control unit 1010 does not calculate the processing amount index nor perform conversion of data into metadata and converts only the feature character string into metadata in step S1322. Alternatively, in order to generate a format similar to a format of other attributes, metadata with a processing amount index of zero can be generated and added.

If the region attribute is GRAPHIC in step S1302, the process proceeds to step S1330. In step S1330, the system control unit 1010 vectorizes the data. Subsequently in step S1331, the system control unit 1010 calculates the processing amount index necessary in rendering. If the object has a special effect and is painted or translucent, the index is calculated taking a processing amount of the special effect into consideration. Next, in step S1332, the system control unit converts the processing amount index into metadata.

If vectorization of the object and conversion of the processing amount index into metadata are completed, then in step S1350, the system control unit 1010 determines whether processing for one page is completed. If it is not completed (NO in step S1350), then in step S1360, the system control unit 1010 adds the processing amount index to the processing amount of the processed page. Then, the process returns to step S1302, and processing of the next object is performed (processed amount index in page unit).

If it is determined in step S1350 that the page processing is completed (YES in step S1350), then in step S1351, the system control unit 1010 adds the processing amount index of the processed page to the entire processing amount index of the document. In step S1352, the system control unit 1010 determines whether the processing of the last page is completed. If it is determined that the last page is not processed (NO in step S1352), the process returns to step S1301 and the system control unit processes the next page. If it is determined that the last page is processed in step S1352 (YES in step S1352), then in step S1353, conversion of the whole data into the document format is completed (whole processing amount index) and the processing of FIG. 13 ends.

It is to be noted that processing for generating a document including PDL data from a printer driver of a PC is the same as generating a document from an input image data except that the input data is data output by an application. Thus, further detailed description of the process flow of the document generation by the printer driver is omitted.

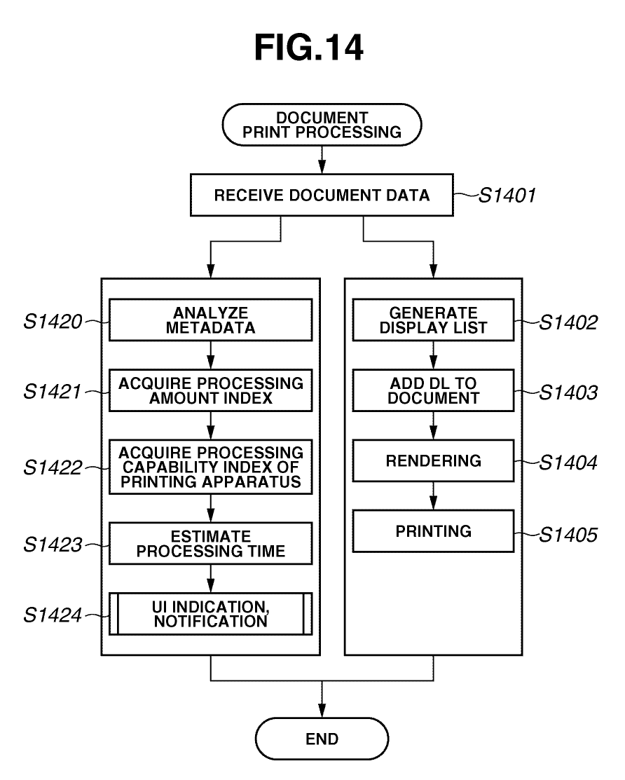

FIG. 14 is a flowchart illustrating processing of a document which includes vector data and metadata by the apparatus printing the document.

In step S1401, the system control unit 1010 receives the document data. Subsequently, rasterization of vector data starting from step S1402 and analysis of additional information starting from step S1420 are started in parallel. In step S1402, the system control unit 1010 generates a DL from the vector data in the document.

Next, in step S1403, the system control unit 1010 adds the generated DL to the document and renders the DL to a bitmapped image in step S1404. In step S1405, the system control unit 1010 executes print processing on a paper medium and the processing ends.

On the other hand, in the additional information analysis starting from step S1420, the system control unit 1010 analyzes the metadata acquired from the document data. In step S1421, the system control unit 1010 acquires the processing amount index from the metadata. The processing amount index may include physical print page count as well as processing amount necessary in rendering. Next, in step S1422, the system control unit 1010 acquires processing capability information of the processing apparatus that prints the document. The capability information includes a rendering capability and a print speed (ppm) of the printer engine (acquisition of apparatus processing capability).

In step S1423, the system control unit 1010 calculates estimated time necessary in rendering based on the processing amount index necessary in the rendering processing and the rendering capability information of the processing apparatus which prints the document acquired in step S1422 (image processing time estimation). Further, the system control unit 1010 calculates actual time necessary in forming the image by the printer engine from the page count and the engine speed. In step S1424, the calculated estimated processing time is notified to the user or notified to a PC or another apparatus that is connected to the network. Further, as the rendering processing and the print processing proceed, the system control unit 1010 updates the processing time. The system control unit 1010 makes necessary notification until the whole processing is completed. Details of step S1424 will be described below.

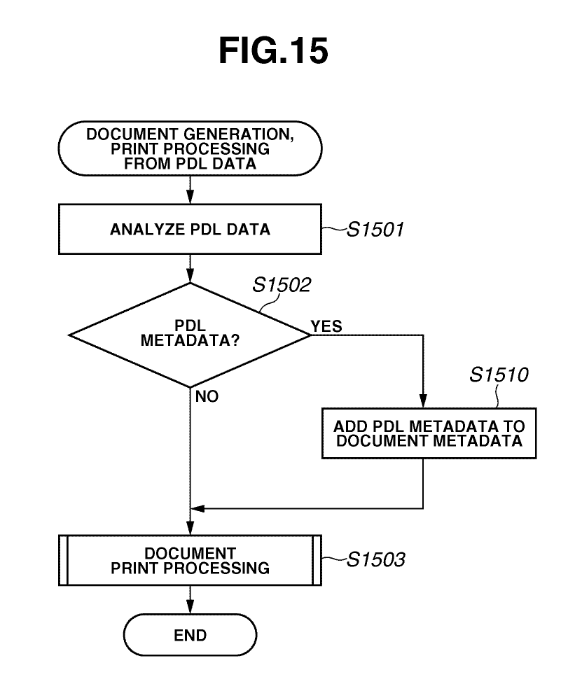

FIG. 15 is a flowchart illustrating a print process of the PDL data. According to this processing, PDL data including a document is printed. The document is generated by the printer driver of the PC.

First, in step S1501, the system control unit 1010 analyzes the PDL data. In step S1502, the system control unit 1010 determines whether metadata is included in the PDL data. If metadata, such as character string information, is included in the PDL data (YES in step S1502), then the process proceeds to step S1510. In step S1510, the system control unit 1010 adds the metadata of the PDL data to the metadata of the document, and the process proceeds to step S1503.

On the other hand, if metadata is not included in the PDL data (NO in step S1502), then the process proceeds to step S1503. In step 1503, the system control unit 1010 processes data other than the metadata. This processing is the same as (or alternatively similar to) the document print processing described referring to FIG. 14. Thus, in step S1503, when the printing is performed on a paper medium, simultaneously, a user is notified of the estimated end time, and then the system control unit 1010 ends the print processing.

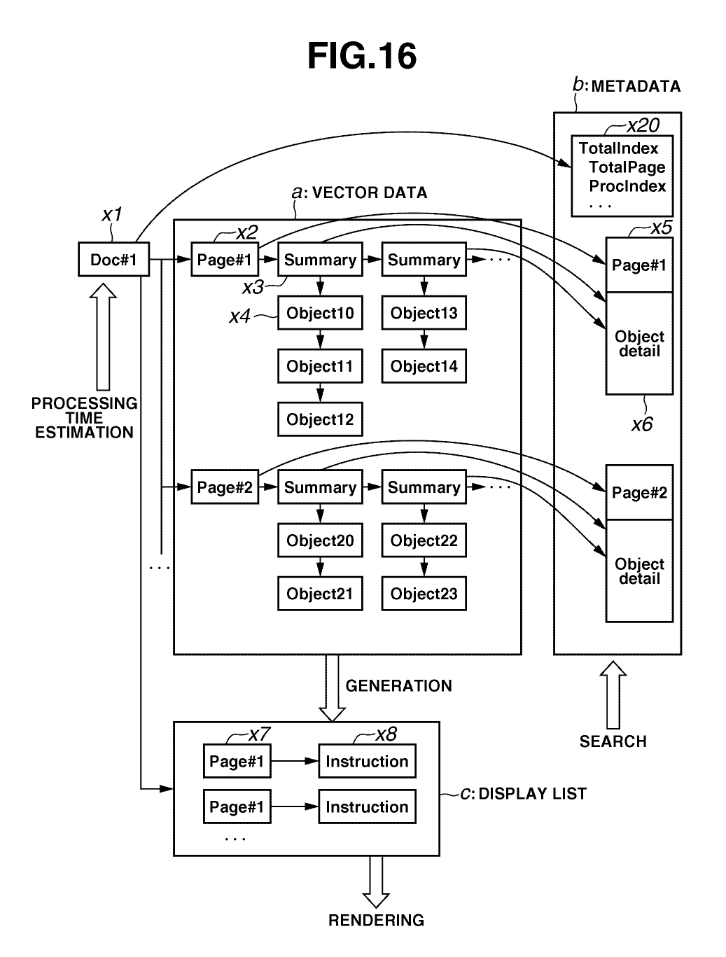

FIGS. 16, 17, and 18 illustrate a structure of a document.

FIG. 16 illustrates a data structure of a document. The document is data including a plurality of pages. The data includes, in a broad categorization, vector data (a), metadata (b), and DL (c), and has a hierarchical structure with a document header (x1) at the top. The vector data (a) includes a page header (x2), summary information (x3), and an object (x4). The metadata (b) includes page information (x5) and detailed information (x6). The DL (c) includes a page header (x7) and a rendering instruction (x8). Since the data location of the vector data and the data location of the DL are described in the document header (x1), the vector data is associated with the DL by the document header (x1).

Since the vector data (a) is rendering data that is independent of print resolution, layout information, such as page size and orientation, is included in the page header (x2). An object (x4) that is rendering data, such as line, polygon, and Bezier curve, is linked one by one to the summary information (x3). As a whole, a plurality of objects (x4) are linked to the summary information (x3). The summary information (x3) describes a feature of the plurality of objects as a whole and includes attribute information of a segmented region that is described with reference to FIG. 12.

The metadata (b) is additional information that is unrelated to the rendering processing. The metadata (b) includes information necessary for estimating processing time, such as processing amount index and page count, as well as information used for search. The page information (x5) includes processing amount index necessary in rendering the rendering data included in the page. The detailed information (x6) includes object details including OCR information and a generated character string (character code string) as image information.

Further, the metadata (b) includes total information (x20) in which information, such as rendering amount index and total page count, of the entire document is included. The total information (x20) is designed to contribute to an acquisition of the processing amount and page count of the whole document at an early timing when the document processing is performed. Thus, the total information (x20) is configured so that it can be directly referred from the document header (x1). Similarly, the page information (x5) is linked to each page header (x2) so that the processing amount index of the relevant page can be smoothly acquired for each page (addition of the whole processing amount or in a page unit).

Further, since metadata is linked to the summary information (x3) of the vector data (a), the detailed information (x6) can be searched from the summary information (x3).

The DL (c) is intermediate code which is used by the renderer when the renderer rasterizes data into bitmapped data. A page header (x7) includes a management table of rendering information (instruction) in a page and the instruction (x8) includes rendering information dependent on print resolution.

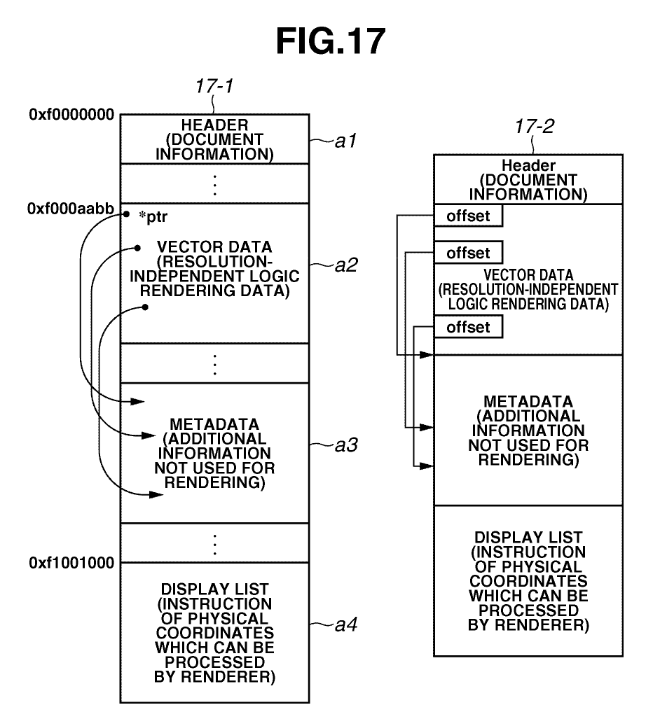

FIG. 17 illustrates an arrangement of the data structure, which is described with reference to FIG. 16, in a memory and in a file.

As illustrated in a data structure 17-1 having header regional, a vector data region a2, a metadata region a3, and a DL region a4 of the document are arranged in an arbitrary address in the memory.

As illustrated in a data structure 17-2, the vector data region, the metadata region, and the DL region of the document are serialized in a file.

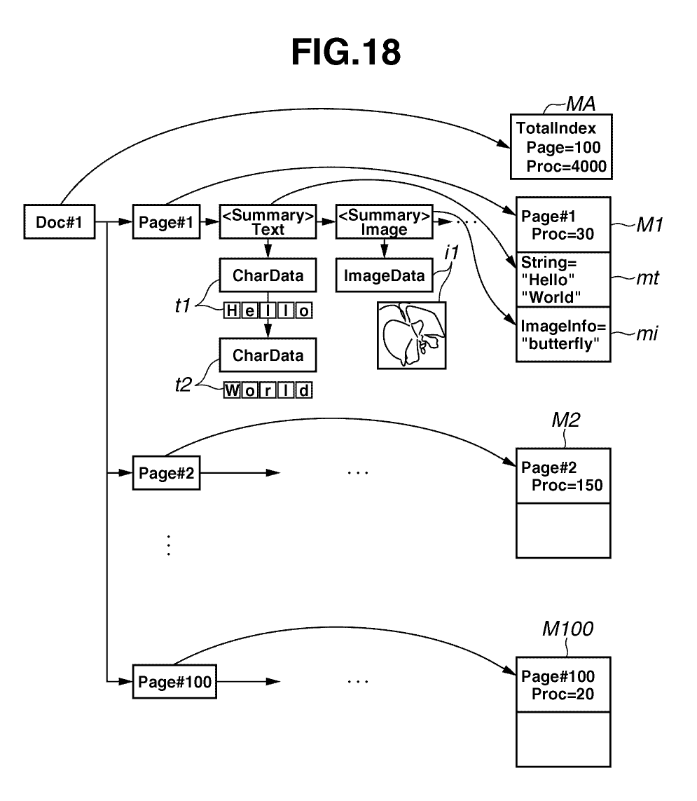

FIG. 18 illustrates a concrete example of a document including 100 pages. The processing amount index and the page count of the entire document are stored in a total information portion MA of the metadata. In FIG. 18, the page count is 100 and the processing amount index is 4000. If the image processing apparatus receives and processes a document, the entire information of the metadata can be referred to directly from the document header without analyzing the image data content. In this way, the image processing apparatus can estimate the end time and make a notification at timing of the processing start time. Further, a processing amount index for each page is stored in metadata portions M1 to M100 corresponding to each page. The processing amount index of page 1 is 30, page 2 is 150, and page 100 is 20. A total of the processing amount index for each page will be the processing amount index of the entire document that is stored in the total information portion MA.

The processing amount index is stored for each page so that while the image processing apparatus is processing the document, a processing status or the remaining processing time can be notified to the user. For example, although pages 1 and 100 illustrated in FIG. 18 are comparatively light pages, page 2 has a larger processing amount index and its processing takes time. By subtracting a processing amount of a page from the whole processing amount each time a page is processed, a remaining processing amount index and waiting time can be calculated more precisely (concrete example of processing amount and page count).

Further, a detailed configuration of the document data will be described taking page 1 as an example. Summary information of page 1 includes “TEXT” and “IMAGE”. Character contours “H,e,l,l,o” (object t1) and “W,o,r,l,d” (object t2) are linked to the summary information of the “TEXT” as vector data. In addition, character code strings (metadata mt) “Hello” and “World” are referred to from the summary information.

Further, a photo image of a butterfly (object i1) in Joint Photographic Experts Group (JPEG) format is linked to the summary information of the “IMAGE”. Furthermore, image information (metadata mi) “butterfly” is referred to from the summary information. Thus, for example, if a text is searched using a keyword “World”, the search will be made by acquiring vector page data sequentially from a document header and then searching metadata which is linked to “TEXT” from the summary information linked to the page header.

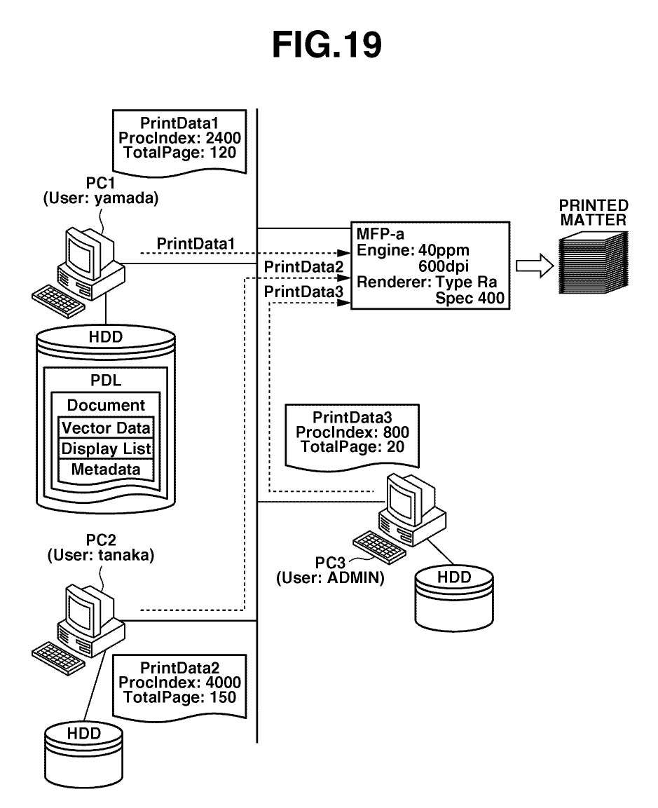

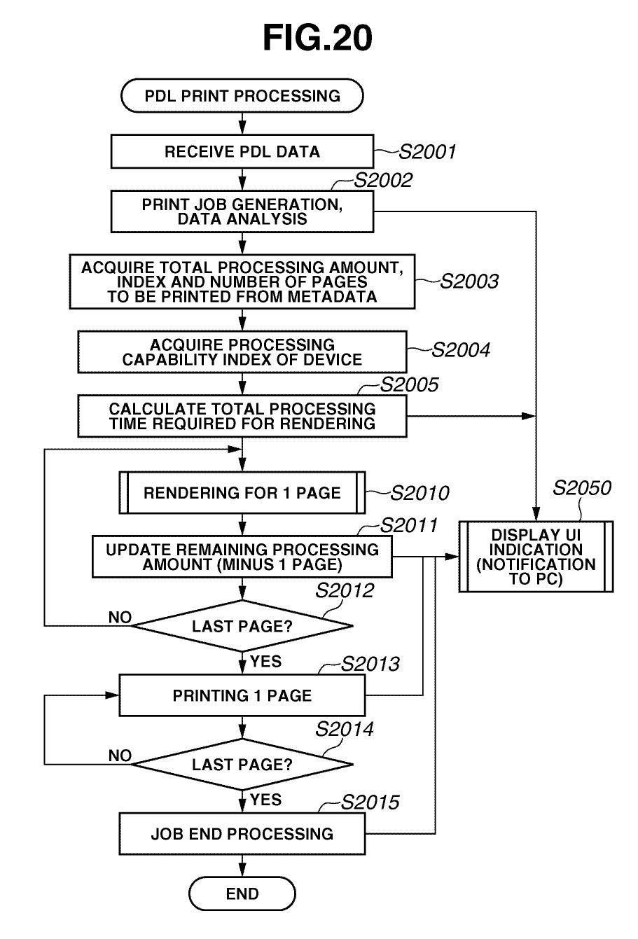

The estimation and display of the PDL printing and the job end time according to the present exemplary embodiment will now be described referring to FIGS. 19 and 20. FIG. 19 illustrates a system configuration including a PC 1, a PC 2, and a PC 3, which generate PDL data, and an MFP-a connected to a network. Each PC has a secondary storage device, such as an HDD, and the PDL data that is generated by a printer driver on the PC is temporarily stored in the HDD of the PC and then sent to the MFP-a. Content of the PDL data generated by the printer driver is a document generated by associating the above-described vector data with the metadata. Generation processing of the document data is described above with reference to FIGS. 10 and 13, so that detail description thereof is not repeated here.

In FIG. 19, each user of the PC 1, the PC 2, and the PC 3 is executing a PDL printing operation at the same time with the MFP-a. Broken lines with an arrow show the transmission of the PDL data. The PDL data sent from the PC 1, the PC 2, and the PC 3 is PrintData1, PrintData2, and PrintData3. A processing amount index and page count of each of PrintData1, PrintData2, and PrintData3 are added as metadata. The MFP-a receives the PDL data sent from the PC 1, the PC 2, and the PC 3 and performs printing.

The processing of the MFP-a will now be described with reference to the flowchart in FIG. 20. In step S2001, the system control unit 1010 receives the PDL data via the network interface 211. In step S2002, the system control unit 1010 generates a print job and temporarily stores the PDL data in the HDD 208. The PDL data is sent from the PC to the MFP-a using a printing protocol. User name and file name of the PDL printing are added to the printing protocol. In step S2050, the system control unit 1010 displays job information, such as the user name and the file name, of the generated print job on the operation unit 210.

In step S2003, the system control unit 1010 acquires a processing amount index of rendering and number of pages to be printed from the total information portion MA of metadata of the document in order to estimate job end time. In step S2004, the system control unit 1010 acquires capability information of the MFP-a that is also necessary in calculating the job end time. In step S2005, the system control unit 1010 calculates time necessary in rendering and time necessary in printing. The estimated end time which is calculated is displayed on the operation unit 210 in step S2050.

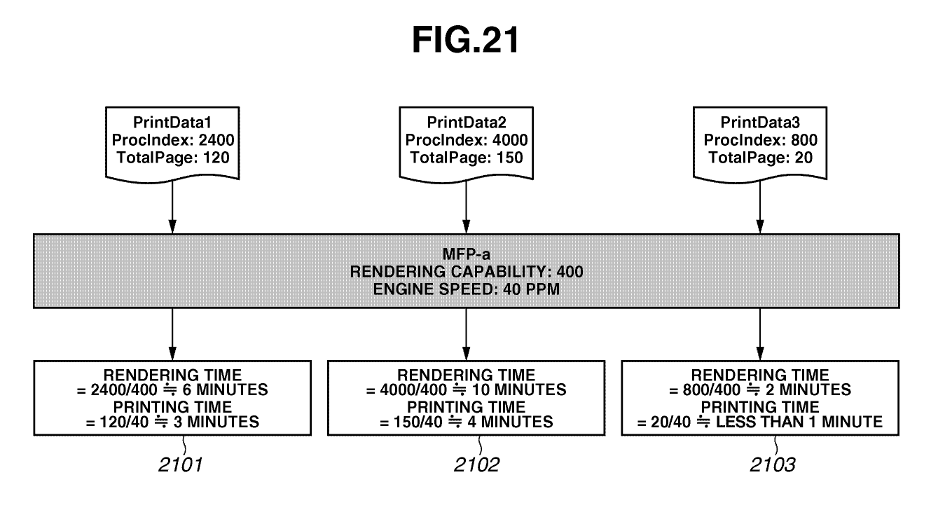

Referring now also to FIG. 21, a concrete example of a calculation of the processing time from the processing amount index and page count will be described. PrintData1 has a processing amount (ProcIndex) of 2400 and the total number of pages is 120. The rendering capability index of the MFP-a is 400 and the printer engine speed is 40 ppm. From these values, the system control unit 1010 calculates the rendering time and the printing time (image forming time estimation). PrintData1 is estimated to take approximately 6 minutes for rendering and approximately 3 minutes for printing. The calculation results are displayed on the operation unit 210 in the form of job information. FIG. 21 illustrates the calculation results of PrintData1 (2101), PrintData2 (2102), and PrintData3 (2103). The rendering time of PrintData2 is 10 minutes and the printing time is 4 minutes. The rendering time of PrintData3 is 2 minutes and the printing time is less than 1 minute.

Referring still to FIG. 20, next, in step S2010, the system control unit 1010 starts the rendering process and the print process. In step S2011, the system control unit 1010 subtracts a processing amount of the completed page from the remaining total processing amount which is stored in the metadata portions (M1, M2, and M3) each time the rendering of one page is completed, updates the processing time of the remaining job, and also updates the display of the operation unit 210. In step S2012, if the page that is rendered is the last page (YES in step S2012), then the rendering process ends and the process proceeds to step S2013, in which the print process by the printer engine starts. The rendered pages can be printed even if the rendering of the last page is not finished. Thus, the printing operation can be started in parallel with the rendering process. The printing operation by the printer engine in step S2013 is continued until the last page. Each time one page is printed, the system control unit 1010 updates the page count displayed on the operation unit 210.

When the last page is printed (YES in step S2014), then in step S2015, the system control unit 1010 ends the processing, updates the display of the operation unit 210, and ends the job. The same type of processing is performed for PrintData2 and PrintData3. The processing time of PrintData2 and PrintData3 is displayed on the operation unit 210 according to the data content and updated as the processing proceeds.

Reference is now made again to FIGS. 6 and 7. FIGS. 6 and 7 illustrate a display screen displaying a job status during the PDL printing. FIG. 6 is a print job list screen 601, on which three jobs 620, 621, and 622 are displayed. A reception number 611 is a number that the system control unit 1010 has assigned to each job, a time 612 is a job reception time, and a job name 613 is a file name of the job. A user name 614 is a name of the user, a status 615 is a job status, a waiting time 616 is the approximate estimated time left until the printing job is completed. A priority print button 630 is for changing processing order of the jobs, a details button 631 is for displaying details of each printing job, a cancel button 632 is for canceling the job, and a back button 633 is for returning to the basic screen of the operation unit 210, which is described referring to FIG. 5.

In FIG. 6, the PDL print processing by the PC 1, the PC 2, and PC 3 are displayed as jobs 620, 621, and 622. Each screen illustrated in FIG. 7 can be displayed by highlighting a job on the job list screen and selecting the details button 631.

A screen 701 shows detailed information of the job 620, a screen 751 shows detailed information of the job 621, and a screen 771 shows detailed information of the job 622. A pause button 720 can be selected to temporarily stop the processing, a close button 721 can be selected to return to the job list screen (FIG. 6). The pause button 720 and the close button 721 are shared by the screens 701, 751, and 771.

The screen 701 is a detail screen of the job 620, in other words, a job detail screen of PrintData1. Job information 702 includes information such as a user name and a document name. A field 703 shows a status of the rendering processing. According to the screen 701, the rendering of all 120 pages is completed. A field 704 shows the number of output pages. Printing of 28 pages out of 120 pages is completed. A field 705 shows an output time of the job. The printing will take approximately two minutes until it is completed. A field 706 shows a total time necessary in completing the printing of the job 620 and the processing of other jobs which the MFP-a holds. Since the job 620 is the first of all jobs, “approximately 2 minutes” is displayed in both fields 705 and 706.

The screen 751 is a detail screen of the job 621, in other words, a job detail screen of PrintData2. Job information 752 includes information such as a user name and a document name. A field 753 shows a status of the rendering processing. According to the screen 751, rendering of 75 pages out of 150 pages is completed. Afield 754 shows the number of output pages. Printing of not even one page of 150 pages is completed. A field 755 shows an output time of the job. The rendering processing has approximately 5 minutes remaining and the printing processing has approximately 4 minutes remaining. A field 756 shows a total time necessary in completing the printing of the job 621 and the processing of other jobs that the MFP-a holds. Since the job 621 will be started after the job 620, “approximately 11 minutes” is displayed in the field 756.

The screen 771 is a detail screen of the job 622, in other words, a job detail screen of PrintData3. Job information 772 includes information such as a user name and a document name. A field 773 shows a status of the rendering processing and a field 774 shows the number of output pages. None of the pages is completed. A field 775 shows an output time of the job. The rendering will take approximately 2 minutes and the printing will take approximately 1 minute. A field 776 shows a total time necessary in completing the printing of the job 622 and the processing of other jobs that the MFP-a holds. Since the job 622 will be started after the jobs 620 and 621, “approximately 13 minutes” is displayed in the field 776.

The display of the estimated end time of the rendering processing and the estimated end time of the print processing are updated as the processing in steps S2011 and S2013 proceeds and notified to the operator via the operation unit 210. In step S2050, the system control unit 1010 not only displays the estimated end time on the operation unit 210 of the MFP-a but also can notify the operator of the estimated end time via an application on the PC.

### Second Exemplary Embodiment

In the first exemplary embodiment, a PDL printing operation directed from a PC to an MFP is described. According to a second exemplary embodiment of the present invention, a document stored in an MFP is reused and printed out on a plurality of MFPs, namely MFP-a, MFP-b, and MFP-c. According to the present exemplary embodiment, metadata of a processing amount included in the generated document can be used repeatedly and even if the number of destinations is increased, a load of the data sending apparatus is not increased. Further, since the processing time is estimated by each MFP based on the processing amount of the received document and the capability of the MFP itself, precise estimated processing time can be calculated even if the capability of the connected apparatuses is different. The rendering and printing times for MFP-a, MFP-b, and MFP-c are shown respectively at 2201, 2202, and 2203, and described further below.

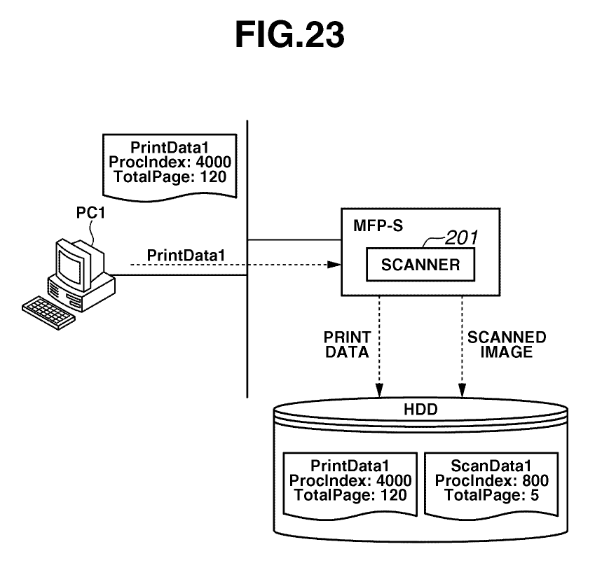

FIG. 23 illustrates a system including an MFP-S configured to store a document. The document data can be data sent from a PC 1 or data acquired by scanning a paper document by the scanner 201 in the MFP-S. In either case, according to the document generation processing described above with reference to FIG. 13, the processing amount index and the page count are recorded in the metadata portion of the document data.

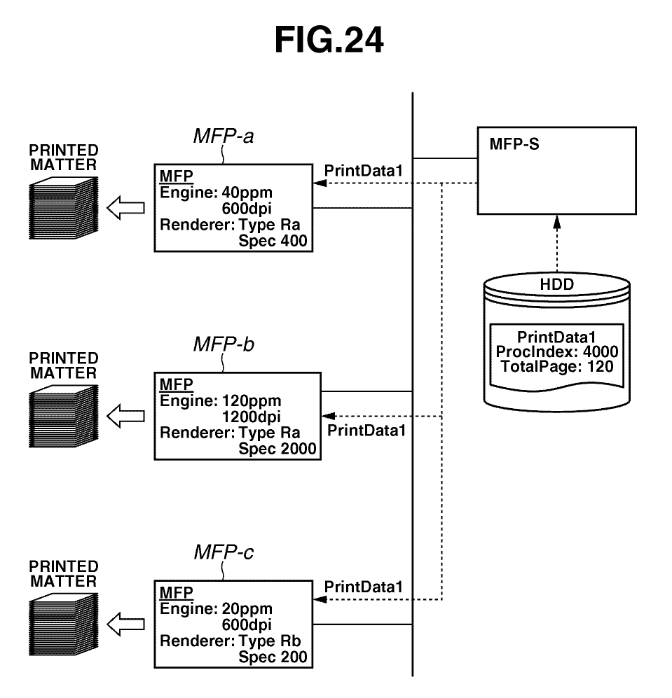

Next, FIG. 24 illustrates a configuration in which a document is printed out at the same time by a plurality of MFPs each having a different capability. Here, PrintData1 which is a document stored in the MFP-S in FIG. 23 is printed by the MFP-a, the MFP-b, and the MFP-c at the same time. When the operator selects MFPs using an operation unit of the MFP-s and specifies PrintData1, PrintData1 is sent to the MFP-a, the MFP-b, and the MFP-c at the same time. Each MFP that received PrintData1 starts print processing. Since the print processing performed by each MFP is the same as (or alternatively similar to) that described in the first exemplary embodiment.

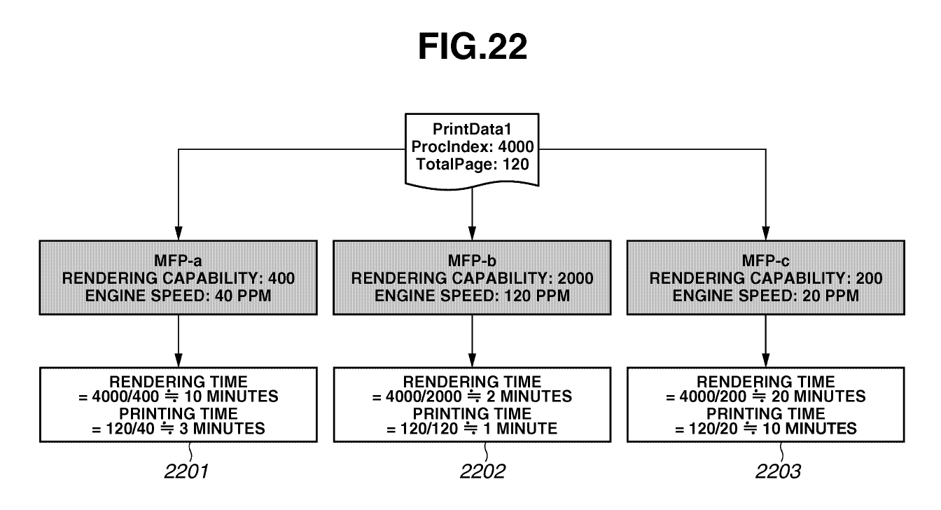

In addition to performing the printing operation, each MFP calculates the estimated time necessary in rendering and printing based on the metadata included in the document and the capability information of the MFP itself. The estimated time of processing of PrintData1 calculated by the MFP-a, the MFP-b, and the MFP-c is illustrated in FIG. 22. PrintData1 is a 120-page document with a rendering processing amount of 4000. The MFP-a has a rendering capability of 400 with an engine speed of 40 ppm, thus the estimated time for rendering is 10 minutes and the estimated time for printing is 3 minutes (estimation result 2201). The MFP-b has a rendering capability of 2000 with an engine speed of 120 ppm, thus the estimated time for rendering is 2 minutes and the estimated time for printing is 1 minute (estimation result 2202). The MFP-c has a rendering capability of 200 with an engine speed of 20 ppm, thus the estimated time for rendering is 20 minutes and the estimated time for printing is 10 minutes (estimation result 2203).

Each MFP updates the display of the waiting time or the notification to the operator according to the progress made in the rendering and printing until the print processing of PrintData1 is completed.

PrintData1 can be reused by the MFP-a, the MFP-b, and the MFP-c even after the printing is completed if PrintData1 is stored in the HDD. The processing amount index and page count information added to the metadata can be reused when PrintData1 is printed again or even when PrintData1 is sent to another apparatus for printing. Further, the apparatus sending PrintData1, which is the MFP-S in the present exemplary embodiment, does not need to calculate the processing amount index for apparatuses to which to output PrintData1. Accordingly, even if PrintData1 is output to a great number of apparatuses having a different processing capability, the processing amount in the MFP-S remains unchanged.

### Third Exemplary Embodiment

The present exemplary embodiment describes that the processing amount index which is added to the metadata at the time of document generation can be used in the estimation of processing time when a plurality of documents are combined.

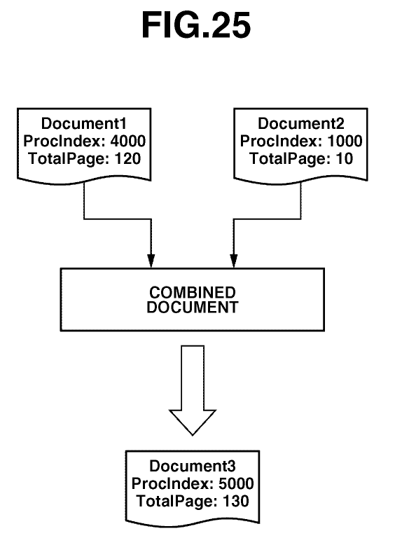

FIG. 25 illustrates an example of metadata of a processing amount in a case where a document 1 and a document 2 are combined into a document 3. As described above, the rendering processing amount added to the document is an index that is independent of a particular apparatus. Accordingly, a processing amount of the newly generated document can be acquired by simply adding the processing amount indexes (and page counts) of the documents that are combined, and thus recalculation of the processing amount becomes unnecessary.

The document 1 is a 120-page document with a rendering processing amount (ProcIndex) of 4000. The document 2 is a 10-page document with a rendering processing amount of 1000. If the two documents are combined, in addition to the vector data portion which is actually printed, the metadata portion is also combined. The rendering processing amount and the page count of the newly generated document 3, which is stored in the total information portion MA of the metadata of the document 3, will be a simple addition of the rendering processing amounts and the page counts of the documents 1 and 2. The processing amount index and the page count of the newly generated document can be used as is with the first exemplary embodiment and the second exemplary embodiment. Further, in a case where the combined document is combined again with another document, the processing amount of the newly combined document can be also acquired by a simple calculation. Complex processing such as analyzing vector data content is not necessary.

### Other Exemplary Embodiments

The present invention can be applied to a system including a plurality of devices, or to an apparatus including a single device. For example, a scanner, a printer, a PC, a copier, a multifunction peripheral or a facsimile machine can constitute exemplary embodiments of the present invention.

The above-described exemplary embodiments can also be achieved by supplying a software program that realizes each function of the aforementioned exemplary embodiments, directly or by remote operation, to the system or the apparatus and a computer included in the system reading out and executing the provided program code.

Thus, the program code itself which is installed in the computer to realize the function and the processing of the present invention on the computer constitutes the above-described embodiments. In other words, the computer-executable program configured to realize the function and the processing of the present invention itself constitutes an exemplary embodiment of the present invention.

In this case, a form of the program can be in any form, such as object code, a program executed by an interpreter, or script data supplied to an operating system (OS) so long as the computer-executable program has a function of a program.

A storage medium for storing the program includes a floppy disk, a hard disk, an optical disk, a magneto-optical disk, a compact disc read-only memory (CD-ROM), a compact disc-recordable (CD-R), a compact disc-rewritable (CD-RW), a magnetic tape, a non-volatile memory card, a ROM, and a digital versatile disc (DVD), such as a DVD-read only memory (DVD-ROM) and a DVD-recordable (DVD-R).

Further, the program can be downloaded by an Internet/intranet website using a browser of a client computer. The computer-executable program of an exemplary embodiment of the present invention itself or a file including compressed program and has an automated install function can be downloaded from the website to a recording medium, such as a hard disk. Further, the present invention can be realized by dividing program code of the program into a plurality of files and then downloading the files from different websites. In other words, a World Wide Web (WWW) server by which a program file used for realizing a function of the exemplary embodiments on a computer is downloaded to a plurality of users can also constitute an exemplary embodiment of the present invention.

Furthermore, the program of an exemplary embodiment of the present invention can be encrypted, stored in a recording medium, such as a CD-ROM, and distributed to users. In this case, the program can be configured such that only the user who satisfies a predetermined condition can download an encryption key from a website via the Internet/intranet, decrypt the encrypted program by the key information, execute the program, and install the program on a computer.

Further, the functions of the aforementioned exemplary embodiments can be realized by a computer which reads and executes the program. An operating system (OS) or the like running on the computer can perform a part or whole of the actual processing based on the instruction of the program. This case can also realize the functions of the aforementioned exemplary embodiments.

Further, a program read out from a storage medium can be written in a memory provided in a function expansion board of a computer or a function expansion unit connected to the computer. Based on an instruction of the program, the CPU of the function expansion board or a function expansion unit can execute a part or all of the actual processing. The functions of the aforementioned exemplary embodiments can be realized in this manner.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-019468 filed Jan. 30, 2007, which is hereby incorporated by reference herein in its entirety.

What is claimed is:

1. An image processing apparatus comprising:
a processing amount index calculation unit configured to analyze content of image data that is independent of print resolution and to calculate a processing amount index indicating a processing amount necessary in converting the image data into a bitmapped image;
a storing unit configured to store the calculated processing amount index as additional information associated with the image data; and
a sending unit configured to send the image data and the additional information.

2. The image processing apparatus according to claim 1, further comprising an image data generation unit configured to generate the image data that is independent of print resolution.

3. The image processing apparatus according to claim 2, wherein the image data that is independent of print resolution is generated from a bitmapped image.

4. The image processing apparatus according to claim 2, wherein the image data that is independent of print resolution is generated from page description data.

5. The image processing apparatus according to claim 1, wherein the additional information includes number of pages to be printed.

6. The image processing apparatus according to claim 1, wherein the processing amount index calculation unit calculates the processing amount index according to a type of a rendering object included in the image data.

7. The image processing apparatus according to claim 1, wherein the processing amount index calculation unit calculates the processing amount index for each page of the image data.

8. An image processing apparatus comprising:
an image processing unit configured to convert image data that is independent of print resolution into a bitmapped image;
a processing capability index storing unit configured to store a processing capability index indicating a processing capability of the image processing apparatus for converting the image data into the bitmapped image;
an additional information analysis unit configured to read and analyze a processing amount index associated with the image data as additional information; and
an image processing time estimation unit configured to calculate a processing time necessary in converting the image data using the processing capability index stored by the processing capability index storing unit and the processing amount index analyzed by the additional information analysis unit.

9. The image processing apparatus according to claim 8, further comprising a display unit configured to display an estimated time calculated by the image processing time estimation unit.

10. The image processing apparatus according to claim 8, further comprising:
an image forming unit configured to form the bitmapped image converted by the image processing unit on a physical medium; and
an image forming time estimation unit configured to estimate a time necessary in forming an image using number of pages to be printed included in the additional information and a print speed of the image forming unit.

11. The image processing apparatus according to claim 10, further comprising a display unit configured to display an estimated time calculated by the image forming time estimation unit.

12. An image processing system comprising:
a first image processing apparatus comprising a processing amount index calculation unit configured to analyze content of image data that is independent of print resolution and to calculate a processing amount index indicating a processing amount necessary in converting the image data into a bitmapped image, a storing unit configured to store the calculated processing amount index as additional information associated with the image data, and a sending unit configured to send the image data and the additional information; and
a second image processing apparatus comprising an image processing unit configured to convert the image data that is independent of print resolution into a bitmapped image, a processing capability index storing unit configured to store a processing capability index indicating a processing capability of the second image processing apparatus for converting the image data into the bitmapped image, an additional information analysis unit configured to read and analyze a processing amount index associated with the image data as additional information, and an image processing time estimation unit configured to calculate a processing time necessary in converting the image data using the processing capability index stored by the processing capability index storing unit and the processing amount index analyzed by the additional information analysis unit.

13. A method comprising:
analyzing content of image data that is independent of print resolution and calculating a processing amount index indicating a processing amount necessary in converting the image data into a bitmapped image;
storing the calculated processing amount index as additional information associated with the image data; and
sending the image data and the additional information.

14. A method comprising:
converting image data that is independent of print resolution into a bitmapped image;
storing a processing capability index indicating a processing capability of an information processing apparatus for converting the image data into the bitmapped image;
reading and analyzing a processing amount index associated with the image data as additional information; and
calculating a processing time necessary in converting the image data using the stored processing capability index and the analyzed processing amount index.
